(19) United States
(12) Patent Application Publication
(10) Pub. No.: US 2016/0252798 A1
(43) Pub. Date: Sep. 1, 2016

(54) DRIP-PROOF CONNECTING MECHANISM AND ELECTRONIC DEVICE

(71) Applicant: RICOH IMAGING COMPANY, LTD., Tokyo (JP)

(72) Inventor: Hiroki IGI, Kanagawa (JP)

(73) Assignee: RICOH IMAGING COMPANY, LTD., Tokyo (JP)

(21) Appl. No.: 15/048,178

(22) Filed: Feb. 19, 2016

(30) Foreign Application Priority Data
Feb. 26, 2015 (JP) 2015-037488

(51) Int. Cl. G03B 17/08; H04N 5/232; H04N 5/225

(52) U.S. Cl. CPC G03B 17/08; H04N 5/2251; H04N 5/23293

(57) ABSTRACT

A drip-proof connecting mechanism, comprising: a shaft body having a cylindrical surface; a box-shaped body having an opening through which the shaft body is inserted; a ring-shaped member disposed to cover the cylindrical surface of the shaft body; a first water stopping body disposed to cover the cylindrical surface of the shaft body and to be sandwiched between the ring-shaped member and the cylindrical surface of the shaft body; and a second water stopping body disposed to cover an outer circumferential surface of the ring-shaped member and to closely contact the ring-shaped member and the box-shaped body.

### BACKGROUND OF THE INVENTION

The present invention relates to a movable connecting mechanism which connects two components of an electronic device to be able to rotate about a support axis, and particularly to a drip-proof connecting mechanism having a drip-proof mechanism.

In general, an electronic device, such as a digital camera, is provided with an image display device (e.g., an LCD (Liquid Crystal Display)). A digital camera of a type having a movable connecting mechanism (e.g., a hinge structure) by which an image display device is attached to a digital camera body such that the direction of the image display device can be changed is known. By using such a movable connecting mechanism, a user is allowed to capture images at various angles while checking images displayed on the image display device.

Japanese Patent Provisional Publication No. 2005-282776A describes a connecting mechanism having a drip-proof property in which hinge tubes are provided respectively for housings of two components (an input unit and a display unit) of an electronic device and both ends of a pipe having an outer circumference to which packing is attached are inserted into the hinge tubes so that the two components are rotatably connected about an axis of the pipe.

In general, a housing of an electronic device is formed of a plurality of divided hosing members, and the housing members are assembled in a joining manner. Regarding an electronic device having a drip-proof property, the plurality of housing members are joined together via water stopping members, such as a gasket.

### SUMMARY OF THE INVENTION

Packing used for water stopping at a sliding part between a movable unit and a fixed unit is moved to follow movement of the movable unit due to a frictional force applied from the movable unit during sliding motion, and thereby friction is caused at a surface the packing contacting the fixed unit. Therefore, if the packing is disposed to overlap with a gasket for water stopping at a gap of the fixed part, friction is caused on a contacting surface between the packing and the gasket. As a result, the gasket may be damaged, deformed or moved, and thereby the water stopping function is damaged.

Therefore, when the drip-proof connecting mechanism described in the patent document 1 is used, it is impossible to provide a connection part (a gasket) of a housing member to a hinge-tube with which the packing contacts. As a result, a degree of freedom of design of housing is lowered, and thereby workability of a housing member and assemblability of an electronic device is lowered.

The present invention is advantageous in that it provides a drip-proof connecting mechanism having suitable workability of members (e.g., easiness of injection molding or cutting work) and assemblability by enhancing a degree of freedom of design for a drip-proof connecting mechanism.

According to an aspect of the invention, there is provided a drip-proof connecting mechanism, comprising: a shaft body having a cylindrical surface; a box-shaped body having an opening through which the shaft body is inserted; a ring-shaped member disposed to cover the cylindrical surface of the shaft body; a first water stopping body disposed to cover the cylindrical surface of the shaft body and to be sandwiched between the ring-shaped member and the cylindrical surface of the shaft body; and a second water stopping body disposed to cover an outer circumferential surface of the ring-shaped member and to closely contact the ring-shaped member and the box-shaped body.

With this configuration, it becomes possible to enhance a degree of freedom of design for a drip-proof connecting mechanism. As a result, it becomes possible to provide a drip-proof connecting mechanism having suitable workability and assemblability of members.

In at least one aspect, the ring-shaped member may comprise: a first inner surface sandwiching the first water stopping body between the first inner surface and the cylindrical surface of the shaft body; and a second inner surface having a diameter smaller than a diameter of the first inner surface, the second inner surface slidably fitting to the cylindrical surface of the shaft body.

In at least one aspect, the shaft body may be supported movably with respect to the box-shaped body.

In at least one aspect, each of the first water stopping body and the second water stopping body may be formed of elastomer having rubber elasticity, and the ring-shaped member may be formed of solid material not having rubber elasticity.

In at least one aspect, one of the first water stopping body and the second water stopping body may be a dynamic water stopping body suitable for water stopping for a sliding part, and the other of the first water stopping body and the second water stopping body may be a static water stopping body suitable for water stopping for a fixed part.

In at least one aspect, the first water stopping body may be the dynamic water stopping body suitable for water stopping for a sliding part, and the second water stopping body may be the static water stopping body suitable for water stopping for a fixed part.

In at least one aspect, the first water stopping body may be an O-ring.

In at least one aspect, the second water stopping body may be a foam rubber.

In at least one aspect, the second water stopping body may be adhered to the outer circumferential surface of the ring-shaped member with an adhesive agent.

According to another aspect of the invention, there is provided an electronic device, comprising: a main body; a movable unit; and one of the above described drip-proof connecting mechanism which movably connects the movable unit to the main body.

### BRIEF DESCRIPTION OF THE ACCOMPANYING DRAWINGS

FIG. 1 illustrates an outer appearance of a digital single-lens reflex camera (in a state where a display unit is folded) provided with a drip-proof connecting mechanism according to an embodiment of the invention.

FIG. 2 illustrates an outer appearance of the digital single-lens reflex camera (in a state where the display unit is unfolded) provided with the drip-proof connecting mechanism according to the embodiment of the invention.

FIG. 3 is a cross sectional view (a ZX plane) of the drip-proof connecting mechanism according to the embodiment of the invention.

FIG. 4 is a cross sectional view (a YZ plane) of the drip-proof connecting mechanism according to the embodiment of the invention.

FIG. 5 illustrates an outer appearance of a hinge unit of the drip-proof connecting mechanism according to the embodiment of the invention.

FIG. 6 illustrates an outer appearance of the hinge unit (after gaskets are attached) of the drip-proof connecting mechanism according to the embodiment of the invention.

FIG. 7 is a cross sectional view illustrating a portion around an upper shaft in the drip-proof connecting mechanism according to the embodiment of the invention.

FIG. 8 is a cross sectional view illustrating a portion around a lower shaft in the drip-proof connecting mechanism according to the embodiment of the invention.

FIG. 9 is a cross sectional view illustrating a portion around a lateral shaft in the drip-proof connecting mechanism according to the embodiment of the invention.

### DETAILED DESCRIPTION OF THE EMBODIMENTS

Hereinafter, a digital single-lens reflex camera 1 having a connecting mechanism according to an embodiment of the invention is described with reference to the accompanying drawings.

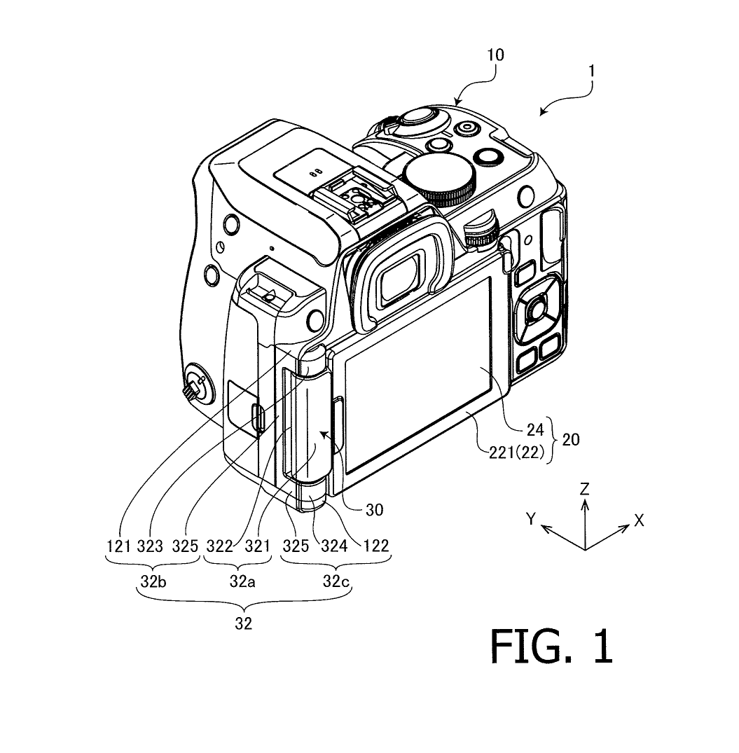

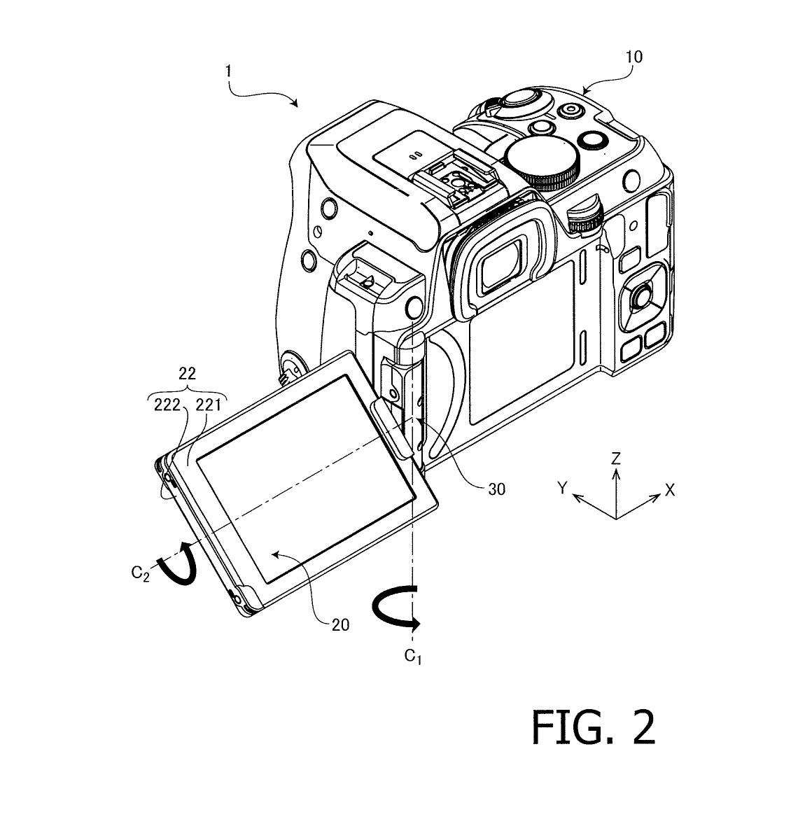

FIGS. 1 and 2 illustrate outer appearances of the digital single-lens reflex camera 1 (hereafter, simply referred to as a “camera 1”). In the following explanations, as shown by the axes of coordinates in FIG. 1, a vertical direction is defined as a Z-axis direction (an upper side in the vertical direction is a positive direction of Z-axis), an optical axis direction of the camera 1 is defined as a Y-axis direction (a subject side is defined as a positive direction of Y-axis), and a direction perpendicular to Z-axis and Y-axis is defined as an X-axis direction (a right side when facing a subject is a positive direction of X-axis) in a state where the camera 1 is positioned horizontally. Further, the positive direction of Z-axis is referred to as an “upper” side, the negative direction of Z-axis is referred to as a “lower” side, the positive direction of X-axis is referred to as a “right” side, and the negative direction of X-axis is referred to as a “left” side.

The camera 1 includes a main body 10, a display unit 20 on which a display device (e.g., an LCD (Liquid Crystal Display)) 24 is mounted, a connecting mechanism 30 which connects the display unit 20 to the main body 10 such that the direction of a display screen of the display device 24 can be changed with respect to the main body 10. FIG. 1 illustrates a state where the display unit 20 is folded to be accommodated in a storage space formed on a rear surface of the main body 10. FIG. 2 illustrates a state where the display unit 20 is unfolded.

As described later, the connecting mechanism 30 includes a two-axis hinge structure, and connects the display unit 20 to the main body 10 such that the display unit 20 is rotatable about two hinge axes: a hinge axis C₁ (an axis parallel with Z-axis) and a hinge axis C₂ (an axis parallel with a lateral direction of the screen of the display device 24).

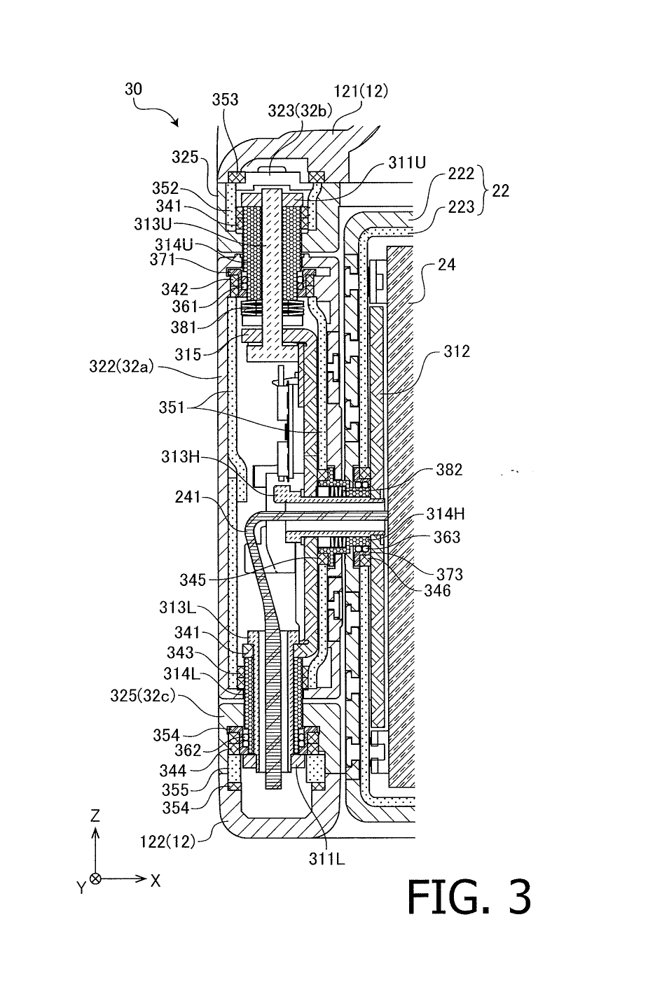

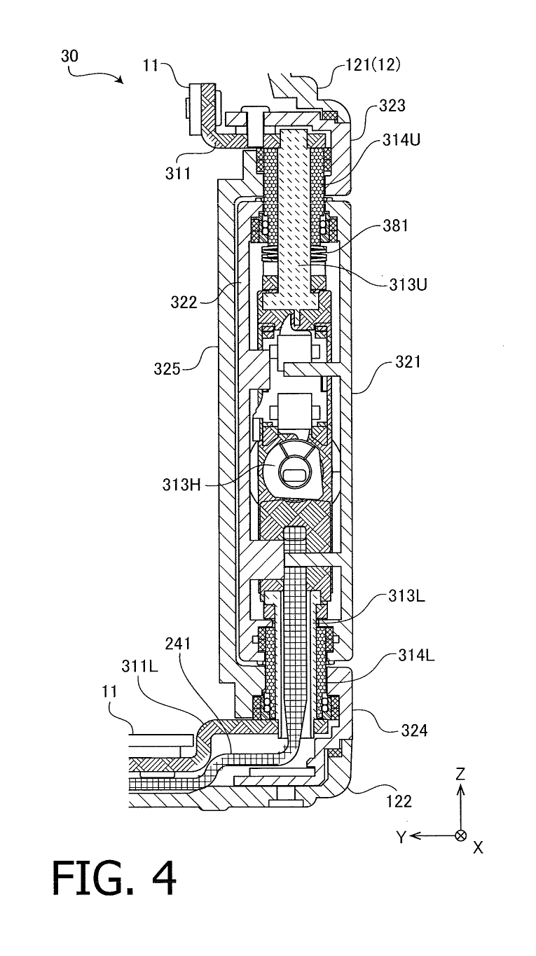

FIGS. 3 and 4 are cross sectional views of the connecting mechanism 30. Specifically, FIG. 3 is a ZX cross sectional view of the connecting mechanism 30 viewed along the optical axis direction (viewed toward the positive direction of Y-axis), and FIG. 4 is an YZ cross sectional view of the connecting mechanism 30 viewed toward the positive direction of X-axis.

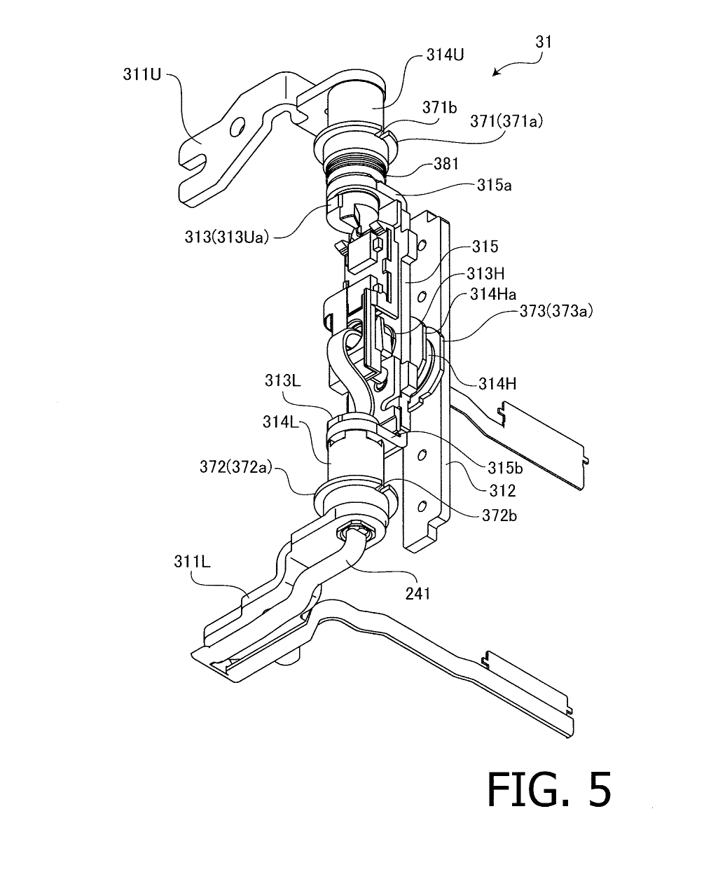

The connecting mechanism 30 includes a hinge unit 31 (see FIG. 5) constituting a framework of the connecting mechanism 30, and an outer packaging (a box-shaped body) 32 covering the hinge unit 31.

FIG. 5 illustrates an outer appearance of the hinge unit 31. The hinge unit 31 is constituted by members which are formed of structural material (material at least not having rubber elasticity), such as stainless steel. The hinge unit 31 has a high degree of rigidity with respect to a force other than torque acting about the hinge axes C₁ and C₂.

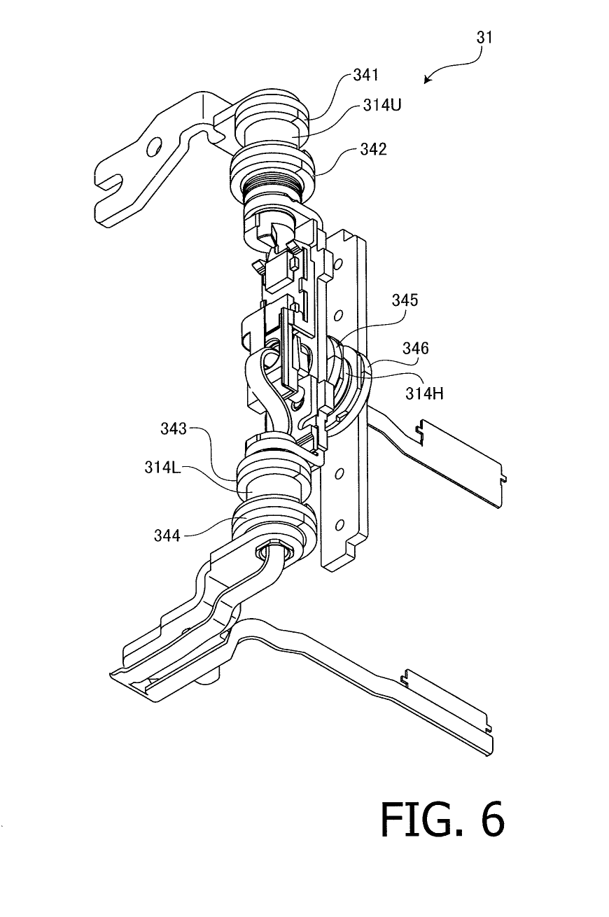

FIG. 6 illustrates a state where gaskets 341 to 346 described later are attached to the hinge unit 31.

The hinge unit 31 includes upper and lower arms 311U and 311L to be fixed to a main body frame 11 (see FIG. 4) of the main body 10, and a display unit fixing plate 312 to be fixed to the display unit 20. The hinge unit 31 further includes an upper shaft 313U whose one end is fixed to a tip part of the upper arm 311U, a lower shaft 313L whose one end is fixed to a tip part of the lower arm 311L, a lateral shaft 313H whose one end is fixed to a central part of the display unit fixing plate 312, and a connecting arm 315 connecting the other ends of the upper shaft 313U, the lower shaft 313L and the lateral shaft 313H. The upper arm 311U is connected to the connecting arm 315 to be rotatable about an axis of the upper shaft 313U, the lower arm 311L is connected to the connecting arm 315 to be rotatable about an axis of the lower shaft 313L, and the display unit fixing plate 312 is connected to the connecting arm 315 to be rotatable about an axis of the lateral shaft 313H.

The hinge unit 31 further includes a tube-like upper spacer 314U fitted to the upper shaft 313U, a tube-like lower spacer 314L fitted to the lower shaft 313L, a lateral spacer 314H fitted to the lateral shaft 313H, a spring 381 disposed to cover the upper shaft 313U, and a spring 382 disposed to cover the lateral shaft 313H.

As shown in FIG. 1, the outer packaging 32 of the connecting mechanism 30 includes a movable front cover 321, a movable rear cover 322, an upper front cover 323, a lower front cover 324 and a rear cover 325, each of which is formed as a plastic molded product.

A movable case 32a is formed by combining the movable front cover 321 and the movable rear cover 322. As shown in FIG. 3, on an inner surface of a connection part of the movable rear cover 322 and the movable front cover 321, a gasket 351 is provided. The gasket 351 is formed as a water stop tape formed by providing an adhesive layer on a surface of a sheet of water stop material, such as a sponge-like EPDM (ethylene-propylene-diene-methylene) foam rubber, and is adhered to the inner surface of the connection part of the movable front cover 321 and the movable rear cover 322.

At an upper edge part of the movable case 32a, an opening through which the upper shaft 313U and the upper space 314U pass is formed. At a lower edge part of the movable case 32a, an opening through which the lower shaft 313L and the lower spacer 324L pass is formed. Further, at a central part of the movable case 32a, an opening through which the lateral shaft 313H and the lateral spacer 314H pass is formed. These openings are formed by letting semicircle recessed parts formed on edges of the movable front cover 321 and the movable rear cover 322 butt with respect to each other.

An upper fixed case 32b is formed by combining the rear cover 325, the upper front cover 323 and a main body upper cover 121 (see FIG. 1). In order to secure a path for letting the upper arm 311U that connects the hinge unit 31 to the main body frame 11 pass therethrough, an inner space of the upper fixed case 32b is formed to communicate with an inner space of an outer packaging (a box-shaped body) 12 of the main body 10.

As shown in FIG. 3, on an inner surface of a connection part between the rear cover 325 and the upper front cover 323, a gasket 352 is provided. Further, on an inner surface of a connection part of the rear cover 325, the upper front cover 323 and the main body upper cover 121, a gasket 353 is provided. The gaskets 352 and 353 are formed of the same material as that of the gasket 351.

At a lower edge part of the upper fixed case 32b, an opening through which the upper shaft 313U and the upper spacer 314U pass is formed.

A lower fixed case 32c is formed by combining the rear cover 325, the lower front cover 324 and a main body lower cover 122 (see FIG. 1). In order to secure a path for letting the lower arm 311L that connects the hinge unit 31 to the main body frame 11 pass therethrough, an inner space of the lower fixed case 32c is formed to communicate with the inner space of the outer packaging 12 of the main body 10.

As shown in FIG. 3, on an inner surface of a connection part between the rear cover 325 and the lower front cover 324, a gasket 354 is provided. Further, on an inner surface of a connection part between the rear cover 325, the lower front cover 324 and the main body lower cover 122, a gasket 355 is provided. The gaskets 354 and 355 are formed of the same material as that of the gasket 351.

At an upper edge part of the lower fixed case 32c, an opening through which the lower shaft 313L and the lower spacer 314L pass is formed.

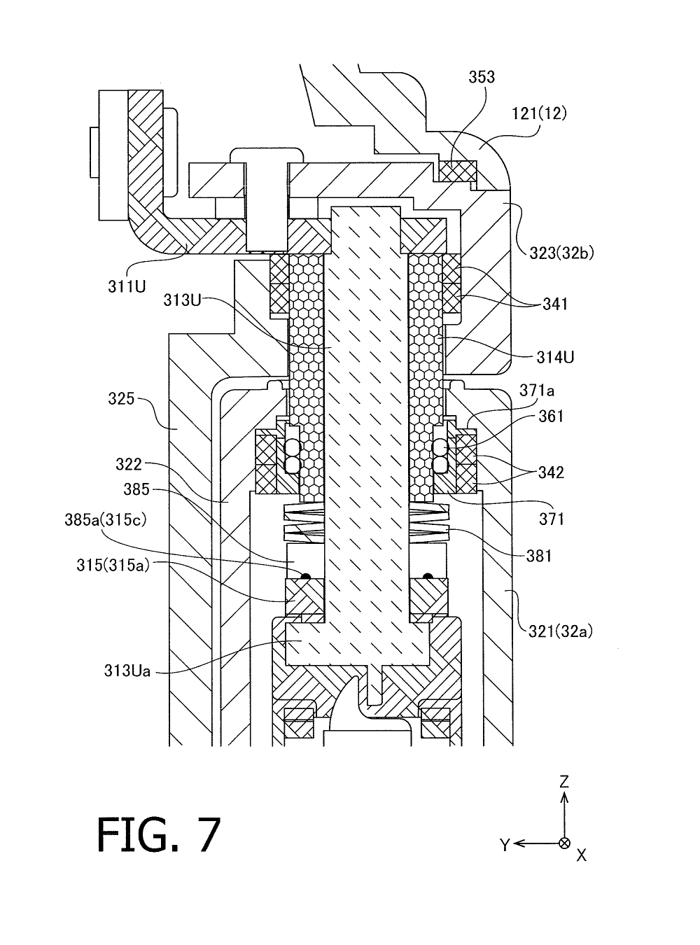

FIG. 7 is an enlarged view of an upper portion (around the upper shaft 313U) in FIG. 4. Upper parts of the upper shaft 313U and the upper spacer 314U are accommodated in the upper fixed case 32b, and lower parts of the upper shaft 313U and the upper spacer 314U are accommodated in the movable case 32a. The upper shaft 313U and the upper spacer 314U are fixed with respect to the upper arm 311U.

On an outer surface of an upper part of the upper spacer 314U accommodated in the upper fixed case 32h, a dual-type gasket 341 is provided. By the gasket 341, it becomes possible to prevent water from entering into the upper fixed case 32b via a gap between the upper spacer 314U and the upper fixed case 32b. The gasket 341 is formed of the same material as that of the gasket 351.

A lower end part of the upper spacer 314U accommodated in the movable case 32a is formed to have a smaller diameter. Two O-rings 361 and a ring-shaped separator 371 (a ring-shaped member) is provided to cover an outer surface (a cylindrical surface) of the smaller diameter part of the upper spacer 341U. The O-ring 361 is an O-ring (e.g., a dynamic O-ring) which is made of elastomer, such as nitrile rubber (NBR: acrylonitrile-butadiene rubber) or silicon rubber, and has adequate durability suitable for water stopping at a sliding part. The separator 371 is a member having a high degree of rigidity made of rigid material (not having rubber elasticity), such as stainless steel. The separator 371 is formed to have a smaller diameter part having a smaller inner diameter at a lower portion on an inner surface thereof. At the smaller diameter part, the separator 371 is slidably fitted to the outer circumferential surface of the upper spacer 341U (e.g., slid fit or clearance fit). The separator 371 is formed with a lager diameter part having a larger inner diameter in an upper portion on the inner circumferential surface of the separator 371, so that the separator 371 is formed to have an L-shaped cross section. The inner diameter of the larger diameter part of the separator 371 is smaller than the outer diameter of the O-ring 361. Therefore, the O-ring 361 is compressed between the outer circumferential surface of the upper spacer 341U and the inner diameter (the larger diameter part) of the separator 371. As a result, water is prevented from entering into the inside of the movable case 32a via a gap between the upper spacer 314U and the separator 371.

The smaller diameter part formed in the lower portion of the inner circumferential surface of the separator 371 is formed to be approximately equal to the smaller diameter part formed on the outer circumferential surface of the upper spacer 341U. Specifically, the smaller diameter part of the outer circumferential surface of the upper spacer 314U and the smaller diameter part of the inner circumferential surface of the separator 371 are formed to be slidably fit with respect to each other (e.g., slid fit or clearance fit).

On an outer circumference of the separator 371, a flange part 371a is formed to fixedly position the separator 371. As shown in FIG. 5, the flange part 371a is formed with a key groove 371b. Further, on an inner wall surface (a lower surface of an upper end part) of the movable front cover 321 which contacts an upper surface of the flange part 371a is formed with a projection (not shown) which engages with the key groove 371b. Due to engagement between the projection of the movable front case 321 and the key groove 371b (i.e., a rotation restriction structure), rotation of the separator 371 with respect to the movable case 32a is restricted. That is, the separator 371 is disposed to rotate around the upper spacer 341U together with the movable case 32a.

On an outer circumferential surface of the separator 371, a dual-type gasket 342 is provided. The gasket 342 is compressed between the outer circumferential surface of the separator 371 and the inner circumferential surface of the movable case 32a. By the gasket 342, water is prevented from entering into the inside of the movable case 32a via a gap between the separator 371 and the movable case 32a. The gasket 342 is made of the same material as that of the gasket 351.

That is, by the O-ring 361, the separator 371 and the gasket 342, water is prevented from entering into the inside of the movable case 32a via a gap between the upper spacer 314U and the movable case 32a. For the upper spacer 341U, there is no necessity to provide a water stopping mechanism because both ends of a hollow portion (i.e., a gap between the upper spacer 314U and the upper shaft 313U) of the upper spacer 341U are opened to watertight spaces (i.e., the inner space of the movable case 32a and the inner space of the upper fixed case 32b).

Through use of the separator 371, it becomes possible to avoid letting the O-ring 361 which is a water stopping member for a sliding part and the gasket 342 (or the gasket 351 (see FIG. 3)) which is a water stopping member for a fixed part directly overlap with each other. As a result, lowering of the drip-proof function due to deterioration or the position shift of the gaskets 342 and 351 caused by friction between the O-ring 361 and the gaskets 342 and 351 according to movement of the O-ring 361 can be prevented.

The connecting arm 315 is a metal plate member bended nearly in a U-shape (see FIG. 5). In bended parts 315a and 315b formed at both ends of the connecting arm 315, bearing holes are formed. The lower part of the upper shaft 313U penetrates through the hollow part of the upper spacer 314U and penetrates through the bearing hole formed in the beaded part 315a on the upper side of the connecting arm 315. A flange part 313Ua is formed at the lower end of the upper shaft 313U, so as to prevent the upper shaft 313U from coming off the bearing hole and moving upward.

The spring 381 disposed to cover the upper shaft 313U is sandwiched between the upper spacer 314U and a locking ring 385, and is compressed. In this configuration, by an elastic restoring force of the spring 381, the locking ring 385 is pressed against the bended part 315a of the connecting arm 315. As a result, a vertical drag force is caused on a contacting surface between the locking ring 385 and the bended part 315a of the connecting arm 315, and thereby an appropriate frictional force is applied to a sliding motion between the locking ring 385 and the bended part 315a (i.e., a rotating motion of the connecting arm 315 with respect to the upper shaft 313U). This frictional force can be adjusted by design of the spring 381, materials of the bended part 315a and the locking ring 385, surface roughness and etc.

The locking ring 385 is fixed to the upper shaft 313U. On a lower surface (a surface contacting the bended part 315a) of the locking ring 385, a plurality of recessed parts 385a are formed to be arranged at constant intervals along a circumferential direction around the center axis. Further, on an upper surface (a surface contacting the locking ring 385) of the bended part 315a of the connecting arm 315, one or more projections 315c respectively corresponding to the recessed parts 385a are formed around the bearing hole. Therefore, each time the connecting arm 315 is rotated by a predetermined angle (corresponding to arrangement intervals of the recessed parts 385a) around the upper shaft 313U, the projections 315c fit into the recessed parts 385a to bring the connecting arm 315 to a locked state (an engaged state).

In order to rotate the connecting arm 315 around the upper shaft 313U in this locked state, it is necessary to pull out the projections 315c from the recessed parts 385a by moving the locking ring 385 (the upper shaft 313U) upward against the elastic restoring force of the spring 381. Therefore, in order to rotate the connecting arm 315 in the locked state, a torque which is larger than a torque required to rotate the connecting arm 315 in an unlocked state where the projections 315 do not fit into the recessed parts 315c is required. As a result, in the locked state, the rotational position of the connecting arm 315 around the upper shaft 313U (the hinge axis C₁) can be stably maintained. For example, by providing the projections 315c and/or the recessed parts 385a at intervals of 5°, the angles at which the connecting arm 315 can be stably maintained can be set at intervals of 5°.

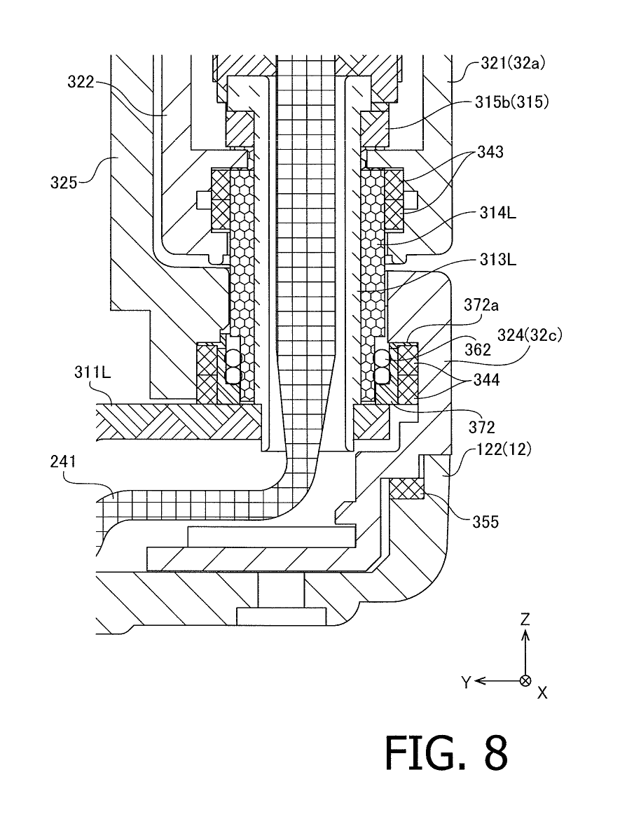

FIG. 8 is an enlarged view of a lower portion (around the lower shaft 313L) in FIG. 4. The lower shaft 313L and the lower spacer 314L are disposed such that upper parts thereof are accommodated in the movable case 32a and lower parts thereof are accommodated in the lower fixed case 32c. The lower shaft 313L is fixed to the lower arm 311L, and the lower spacer 314L is rotatably supported with respect to the lower shaft 313L. Further, the lower spacer 314L is fixed to the movable case 32a at an upper part of the lower spacer 314L.

On an outer circumferential surface of the upper part of the lower spacer 324L accommodated in the movable case 32a, a dual-type gasket 343 is provided. By the gasket 343, water is prevented from entering into the inside of the movable case 32a via a gap between the lower spacer 314L and the movable case 32a. The gasket 343 is made of the same material as that of the gasket 351.

Water stopping at a gap between the lower fixed case 32c and the lower spacer 314L is achieved by the same way as the above described water stopping at the gap between the movable case 32a and the upper spacer 314U. Specifically, an outer circumference of a lower part of the lower spacer 314L accommodated in the lower fixed case 32c is formed to have a smaller diameter, and two O-rings 362 and a separator 372 (a ring-shaped member) are provided to cover the smaller diameter part of the lower spacer 314L. Further, on an outer circumferential surface of the separator 372, a dual-type gasket 344 is provided. The O-ring 362 has adequate durability for water stopping at a sliding part (e.g., a dynamic O-ring). By the three layer structure including the O-ring 362, the separator 372 and the gasket 3′11, water is prevented from entering into the inside of the lower fixed case 32c via a gap between the lower spacer 314L and the lower fixed case 32c. More specifically, by the O-rings 362, water is prevented from entering into the inside of the lower fixed case 32c via the gap between the lower spacer 314L and the separator 372. Further, by the gasket 344, water is prevented from entering into the inside of the lower fixed case 32c via the gap between the separator 372 and the lower fixed case 32c.

The separator 372 is made of rigid material which is the same as that of the separator 371. By engagement between a key groove 372b (see FIG. 5) formed in a flange part 372a of the separator 372 and a projection (not shown) provided on a wall surface of the rear cover 325 contacting the upper surface of the flange part 372a, rotation of the separator 372 with respect to the lower fixed case 32c is restricted.

The lower shaft 313L is a tube-like member, and, in a hollow part of the lower shaft 313L, a flexible printed circuit board 241 is inserted. The flexible printed circuit board 241 is a film type printed circuit member for connecting the display device 24 to a video output unit (not shown) in the main body 10.

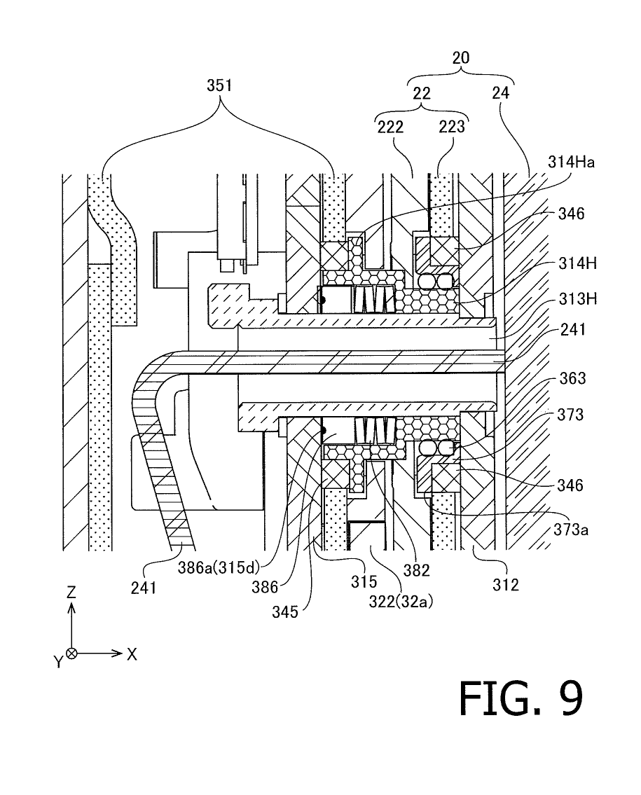

FIG. 9 is an enlarged view of a central portion (around the lateral shaft 313H) in FIG. 3. One end (the left end in FIG. 9) of each of the lateral shaft 313H and the lateral spacer 314H is accommodated in the movable case 32a, and the other end (the right end in FIG. 9) of each of the lateral shaft 313H and the lateral spacer 314H is accommodated in an outer packaging (a box-shaped body) 22 of the display unit 20.

The lateral shaft 313H is disposed such that the right end of the lateral shaft 313H is fitted into a through hole formed in a display unit fixing plate 312 and is fixed to the display unit fixing plate 312. Further, the left end of the lateral shaft 313H is inserted into a bearing hole formed in the connecting arm 315, and is slidably fitted into the bearing hole (rotatably about the axis). A flange part having a diameter larger than the inner diameter of the bearing hole is formed at the left end of the lateral shaft 313H so as to prevent the lateral shaft 313H from coming off the bearing hole of the connecting arm 315.

The lateral spacer 314H is also a tube-like member, and the lateral shaft 313H penetrates through a hollow part of the lateral spacer 314H. An inner circumferential surface of the lateral spacer 314H has a smaller diameter mart on the display unit side, and the smaller diameter part of the inner surface of the lateral spacer 314H is slidably fitted to the outer circumferential surface of the lateral shaft 313H (e.g., slid fit or clearance fit). A flange part 314Ha of the lateral spacer 314H is cut in a shape of a flat-plate (D-cut) at one end part thereof (see FIG. 5). Since the cut surface of the flange part 314Ha contacts the rear surface of the movable front cover 321, rotation of the lateral spacer 314H about the axis with respect to the movable case 32a is restricted.

On the outer circumferential surface of the left end part of the lateral spacer 314H accommodated in the movable case 32a, a gasket 345 is provided. By the gasket 345, water is prevented from entering into the movable case 32a via a gap between the lateral spacer 314H and the movable case 32a. The gasket 345 is made of the same material as that of the gasket 351.

Water stopping via a gap between the lateral spacer 314H and the outer packaging 22 (the display unit front cover 221 and the display unit rear cover 222) of the display unit 20 is achieved by the same way as the above described water stopping via the gap between the movable case 32a and the upper spacer 314U. That is, the outer circumferential surface of the right end part of the lateral spacer 314H accommodated in the outer packaging 22 is formed to be a smaller diameter part, and two O-rings 363 and a ring-shaped separator 373 (a ring-shaped member) are disposed to cover the smaller diameter part of the lateral spacer 314H. Further, a gasket 346 is provided on the outer circumferential surface of the separator 373. The O-ring 363 has adequate durability for water stopping at a sliding part (e.g., a dynamic O-ring). By the three-layer structure including the O-ring 363, the separator 373, and the gasket 346, water is prevented from entering into the outer packaging 22 via the gap between the lateral spacer 314H and the outer packaging 22. Specifically, by the O-ring 363, water is prevented from entering into the inside of the outer packaging 22 via the gap between the lateral spacer 314H and the separator 373. Further, by the gasket 346, water is prevented from entering into the inside of the outer packaging 22 via the gap between the separator 373 and the outer packaging 22.

The separator 373 is made of rigid material which is the same as that of the separator 371. The flange part 373a of the separator 373 is cut (D-cut) in a shape of a flat plate at one end (see FIG. 5). Since the cut surface of the flange part 373a contacts the rear surface of the display unit front cover 221, rotation of the separator 373 about the lateral shaft 313H is restricted.

The gasket 346 is compressed between the outer circumferential surface of the separator 373 and the inner circumferential surface (end faces of the display unit front cover 221 and the display unit rear cover 222) of a counter sinking part formed in the opening of the outer packaging 22 into which the separator 373 is inserted.

The lateral shaft 313H is a tube-like member, and, in a hollow part of the lateral shaft 313H, the flexible printed circuit board 241 is inserted.

On a movable case 32a side of the lateral spacer 314H, a larger diameter part where the inner diameter of the lateral spacer 314H is increased is formed. In a hollow part of the larger diameter part of the lateral spacer 314H, a spring 382 and a locking ring 386 fixed to the lateral shaft 313H are accommodated. The spring 382 is compressed between the locking ring 386 and the lateral spacer 314H. By a restoring force of the spring 382, the locking ring 386 is pressed against the connecting arm 315. As a result, a vertical drag force is caused on a contacting surface between the connecting arm 315 and the locking ring 386, and thereby an appropriate frictional force is applied to sliding motion of the connecting arm 315 with respect to the locking ring 386 (i.e., rotation of the connecting arm 315 with respect to the lateral shaft 313H).

On a contacting surface of the locking ring 386 which contacts the connecting arm 315, a plurality of recessed parts 386a are follned to be arranged at constant intervals along a circumferential direction around the center axis. Further, on a contacting surface of the connecting arm 315 which contacts with the licking ring 386, one or more projections 315d respectively corresponding to the recessed parts 386a are formed around the bearing hole. Therefore, each time the connecting arm 315 is rotated by a predetermined angle (corresponding to arrangement intervals of the recessed parts 386a) around the lateral shaft 313H, the projections 315d fit into the recessed parts 386a to bring the connecting arm 315 to a locked state (an engaged state) and thereby the rotational position of the connecting arm 315 around the lateral shaft 313H (the hinge axis C₂) is kept stably.

The display unit 20 fixed to the lateral shaft 313H is configured to be rotatable by 270° around the hinge axis C₂ (see FIG. 2) with respect to the connecting arm 315 (the main body 10). Therefore, the display device 24 can be retracted into the main body 10 in a state where the display screen is oriented to the front side (i.e., to the negative direction in Y-axis) or in a state where the display screen is oriented to the rear side (i.e., to the main body 10 side). When the display unit 20 is retracted in the main body 10 in a state where the display screen is oriented to the front side, a photographer is allowed to capture an image while viewing the display screen of the display unit 20. When the display unit 20 is retracted in the main body 10 in a state where the display screen is oriented to the rear side, it becomes possible to prevent the display screen from being damaged when the camera 1 is carried.

The movable case 32a and the connecting arm 315 are configured to be rotatable about the hinge axis C₁ by 180° with respect to the main body 10 (directly with respect to the upper arm 311U and the lower arm 311L fixed to the main body 10). Therefore, as shown in FIG. 2, the direction of the display unit 20 can be changed in various ways depending on photographing scenes.

Since, as described above, the connecting mechanism 30 according to the embodiment is configured such that a water stopping member for a sliding part and a water stopping member for a fixed part are separated by a rigid separator (not having rubber elasticity), movement of and damage to the water stopping member for the fixed part is prevented and thereby deterioration of the water stopping property can be prevented.

By using the configuration where the water stopping member (i.e., the O-ring) for the sliding part and the water stopping member (i.e., the gasket) for the fixed part are separated by a separator, it becomes possible to obtain a stable and high degree of water stopping performance even when an O-ring and an opening for letting a rotation shaft (each shaft and each spacer) pass therethrough are provided at a connection part of covers requiring water stopping by a gasket. As a result, the degree of freedom for design of a water stopping mechanism can be enhanced, and thereby a water stopping mechanism having suitable workability, moldability and assemblability can be realized.

In the connecting structure described in the patent document 1, an outer packaging is deformed by a large amount of force applied to a connecting shaft because the connecting shaft is supported by the outer packaging. As a result, the water stopping property may deteriorate. By contrast, according to the connecting mechanism 30 of the embodiment, the hinge unit 30 constituting the framework and the outer packaging 32 are provided independently, and the shafts 313U, 313L and 313H are respectively supported by the arms 311U, 311L and 315 having a high degree of rigidity. Therefore, it is prevented that a large amount of force is applied to the outer packaging 32 when the display unit is rotated. As a result, it becomes possible to prevent deterioration of the water stopping property (drip-proof property) due to deformation of the outer packaging.

Although explanation of the embodiment is given by focusing on the drip-proof property of the connecting mechanism, the connecting mechanism according to the embodiment is also effective for enhancing dust-proof property of electronic devices.

The foregoing is the explanation about the embodiment of the invention. The invention is not limited to the above described embodiment, but can be varied in various ways within the scope of the invention.

In the above described embodiment, the shaft and the spacer are provided as separate members; however, in another embodiment a shaft and a spacer may be integrally formed.

In the above described embodiment, a dynamic water stopping body (for sliding motion) is provided on an inner circumferential surface of a spacer (e.g., the upper spacer 314U) and a static water stopping body (for fixing) is provided on an outer circumferential surface of the spacer; however, the present invention is not limited to such a configuration. The feature of the above described embodiment is that a dynamic water stopping body (for sliding motion) and a static water stopping body (for fixing) are provided separately, and the water stopping members are separated by a spacer. Therefore, a configuration where a static water stopping body (for fixing) is provided on an inner circumferential surface of a spacer and a dynamic water stopping body (for sliding motion) is provided on an outer circumferential surface of the spacer also falls within the scope of the invention.

In the above described embodiment, the connecting mechanism is configured such that only rotational motion about an axis is allowed with respect to a shaft body (e.g., the upper shaft 313U or the upper space 314U). However, the invention can be applied to a configuration where a shaft body is able to translate along an axial direction with respect to a box-shaped body.

In the above described embodiment, EPDM foam rubber is used as a gasket (a static water stopping body), a form body of other types of elastomer (including thermoplastic elastomer) or a non-form body (e.g., a soft gasket such as a rubber sheet or an O-ring) may be used as a gasket (a static water stopping body). Furthermore, artificial leather, fine textile fabrics such as woolen cloth, non-woven fabric (e.g., non-woven fabric whose permeability is lowered by using micro fiber), or ones obtained by subjecting these materials to drip-proof treatment (e.g., a member formed such that a water barrier plastic film is adhered or welded to one side thereof or a member coated with resin and the like) can also be used as a gasket.

In the above described embodiment, an engagement structure of a groove (a key groove) provided on a separator and a projection (a key) provided on an outer packaging or a D-cut structure is used as a rotation restriction structure; however, in another embodiment, other types of rotation restriction structures (e.g., adhesion fixing, welding fixing, crimping fixing, or screwing fixing) may be used.

In the above described embodiment, each of the gaskets 341 to 346 and the O-rings 361 to 363 is provided as a single or dual-type member; however, the number of stages of each of the gaskets 341 to 346 and the O-rings 361 to 363 is not limited to the embodiment. The number of stages of each of the gaskets 341 to 346 and the O-rings 361 to 363 may be independently determined as one, two, three or more.

In the above described embodiment, the locking rings 385 and 386 are formed with the recessed parts 385a and 386a, and the projections 315c and 315d are provided on the connecting arm 315. However, inversely, a configuration in which projections are provided on a locking ring and recessed parts are provided on a connection arm may be used.

In the above described embodiment, the disclosed feature is applied to a variable-angle connecting mechanism for a variable-angle display device (a so-called variable angle LCD). However, the disclosed feature may be applied to various types of electronic devices having a display device, such as, a mirrorless single lens camera, a compact digital camera, a camcoder, a mobile phone, a portable game machine or a personal computer.

The present disclosure may be applied to various types of hinge structures of an openable type electronic device.

This application claims priority of Japanese Patent Application No. 2015-037488, filed on Feb. 26, 2015. The entire subject matter of the applications is incorporated herein by reference.

What is claimed is:

1. A drip-proof connecting mechanism, comprising:
a shaft body having a cylindrical surface;
a box-shaped body having an opening through which the shaft body is inserted;
a ring-shaped member disposed to cover the cylindrical surface of the shaft body;
a first water stopping body disposed to cover the cylindrical surface of the shaft body and to be sandwiched between the ring-shaped member and the cylindrical surface of the shaft body; and
a second water stopping body disposed to cover an outer circumferential surface of the ring-shaped member and to closely contact the ring-shaped member and the box-shaped body.

2. The drip-proof connecting mechanism according to claim 1,
wherein the ring-shaped member comprises:
a first inner surface sandwiching the first water stopping body between the first inner surface and the cylindrical surface of the shaft body; and
a second inner surface having a diameter smaller than a diameter of the first inner surface, the second inner surface slidably fitting to the cylindrical surface of the shaft body.

3. The drip-proof connecting mechanism according to claim 1, wherein the shaft body is supported movably with respect to the box-shaped body.

4. The drip-proof connecting mechanism according to claim 1,
wherein:
each of the first water stopping body and the second water stopping body is formed of elastomer having rubber elasticity; and
the ring-shaped member is formed of solid material not having rubber elasticity.

5. The drip-proof connecting mechanism according to claim 1,
wherein:
one of the first water stopping body and the second water stopping body is a dynamic water stopping body suitable for water stopping for a sliding part; and
the other of the first water stopping body and the second water stopping body is a static water stopping body suitable for water stopping for a fixed part.

6. The drip-proof connecting mechanism according to claim 5,
wherein:
the first water stopping body is the dynamic water stopping body suitable for water stopping for a sliding part; and
the second water stopping body is the static water stopping body suitable for water stopping for a fixed part.

7. The drip-proof connecting mechanism according to claim 1, wherein the first water stopping body is an O-ring.

8. The drip-proof connecting mechanism according to claim 1, wherein the second water stopping body is a foam rubber.

9. The drip-proof connecting mechanism according to claim 1, wherein the second water stopping body is adhered to the outer circumferential surface of the ring-shaped member with an adhesive agent.

10. An electronic device, comprising:
a main body;
a movable unit; and
a drip-proof connecting mechanism according to claim 1,
wherein the drip-proof connecting mechanism movably connects the movable unit to the main body.
